(19) United States
(12) Patent Application Publication
(10) Pub. No.: US 2017/0188085 A1
(43) Pub. Date: Jun. 29, 2017

(54) METHOD AND ELECTRONIC DEVICE FOR MULTI-SCREEN SWITCHING

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xin Li, Beijing (CN)

(21) Appl. No.: 15/243,812

(22) Filed: Aug. 22, 2016

Related U.S. Application Data
(63) Continuation of application No. PCT/CN2016/088998, filed on Jul. 6, 2016.

(30) Foreign Application Priority Data
Dec. 29, 2015 (CN) 201511017435.8

(51) Int. Cl. H04N 21/436; H04N 21/6587; H04N 21/43

(52) U.S. Cl. CPC H04N 21/436; H04N 21/4302; H04N 21/6587

(57) ABSTRACT

The present application discloses a method and an electronic device for multi-screen switching. The method for multi-screen switching includes: playing information about playing contents of a first terminal is acquired, where the playing information includes a playing record and a content identifier; the playing information is transmitted to at least one second terminal so as to indicate the second terminal to conduct play control on the playing contents according to the playing information.

### CROSS-REFERENCES TO RELATED APPLICATIONS

The present application is a continuation application of a PCT application No. PCT/CN2016/088998, filed on Jul. 6, 2016; and claims the priority of Chinese patent application No. 201511017435.8, titled “Method, Server and Terminal for Multi-Screen Switching”, filed on Dec. 29, 2015 to State Intellectual Property Office, the entire content of both application is herein incorporated by reference.

### TECHNICAL FIELD

The present application relates to the field of intelligent terminals, e.g., relates to a method and an electronic device for multi-screen switching.

### BACKGROUND

There are an increasing variety of intelligent terminals in the related art, such as mobile phones, tablet computers, intelligent televisions and the like, which are more and more widely applied in human life. One user often has a plurality of intelligent terminals and intelligent televisions, so that the user hopes to flexibly switch watched audio or video contents among a plurality of intelligent terminals. For example, the user watches a video program on a vehicle through a mobile phone, and exits the video program after getting off the vehicle. After going back home, the user hopes to continue to watch the video program through a television.

A solution of the related art is as follows. When the user watches the video program on the vehicle through the mobile phone, the user exits the video program if the user gets off the vehicle or needs to replace with a second intelligent terminal for continuing to watch the video program due to inadequate power of the mobile phone and occurring of other problems. After going back home, the user continues to watch the video program through the television. Then, the user turns on the television, searches and opens the video program, and needs to manually fast-forward to a previously watched position of the video program to continue to watch.

While realizing the present application, the inventor discovers that there are at least following problems in the related art: a user needs to manually select a position of previous playing content when audio or video contents are needed to be switched among a plurality of intelligent terminals, thereby reducing use experience of the user.

### SUMMARY

The present application provides a method and electronic device for multi-screen switching, thereby realizing free switching of audio or video contents among a plurality of intelligent terminals, and use experience of a user is enhanced.

In a first aspect, embodiments of the present application provide a method for multi-screen switching, including:

acquiring playing information about playing contents of a first terminal, wherein the playing information includes a playing record and a content identifier; and

transmitting the playing information to at least one second terminal so as to indicate the second terminal to conduct play control on the playing contents according to the playing information.

In a second aspect, embodiments of the present application provide a server for multi-screen switching, including:

at least one processor; and

a memory communicably connected with the at least one processor for storing instructions executable by the at least one processor, wherein execution of the instructions by the at least one processor causes the at least one processor to:

acquire playing information about playing contents of a first terminal, where the playing information includes a playing record and a content identifier; and

transmit the playing information to at least one second terminal so as to indicate the second terminal to conduct play control on the playing contents according to the playing information.

In a third aspect, embodiments of the present application provide a non-transitory computer-readable storage medium storing executable instructions that, when executed by an electronic device, cause the electronic device to:

acquire playing information about playing contents of a first terminal, wherein the playing information includes a playing record and a content identifier; and

transmit the playing information to at least one second terminal so as to indicate the second terminal to conduct play control on the playing contents according to the playing information.

### DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram showing a method for multi-screen switching provided in embodiments of the present application;

FIG. 2 is a schematic diagram showing a system architecture used in a method for multi-screen switching provided in embodiments of the present application;

FIG. 3 is a flow diagram showing a method for multi-screen switching provided in embodiments of the present application;

FIG. 4 is a flow diagram showing a method for multi-screen switching provided in embodiment 3 of the present application;

FIG. 5 is a flow diagram showing another method for multi-screen switching provided in embodiment 4 of the present application;

FIG. 6 is a flow diagram showing another method for multi-screen switching provided in embodiment 5 of the present application;

FIG. 7 is a schematic structural diagram showing a server for multi-screen switching provided in embodiment 6 of the present application;

FIG. 8 is a schematic structural diagram showing a terminal for multi-screen switching provided in embodiment 7 of the present application;

FIG. 9 is a schematic structural diagram showing another terminal for multi-screen switching provided in embodiment 8 of the present application;

FIG. 10 is a flow diagram showing another method for multi-screen switching provided in embodiment 9 of the present application;

FIG. 11 is a functional block diagram showing a hardware structure of a server provided in embodiments of the present application;

FIG. 12 is a functional block diagram showing a hardware structure of a first terminal provided in embodiments of the present application; and

FIG. 13 is a functional block diagram showing a hardware structure of a second terminal provided in embodiments of the present application.

### DETAILED DESCRIPTION

The present application will be described in detail below in combination with drawings and embodiments. It should be understood that embodiments described here are only used for explaining the present application, not used for limiting the present application. In addition, it should be noted that for ease of description, the drawings only show some structures related to the present application rather than all structures.

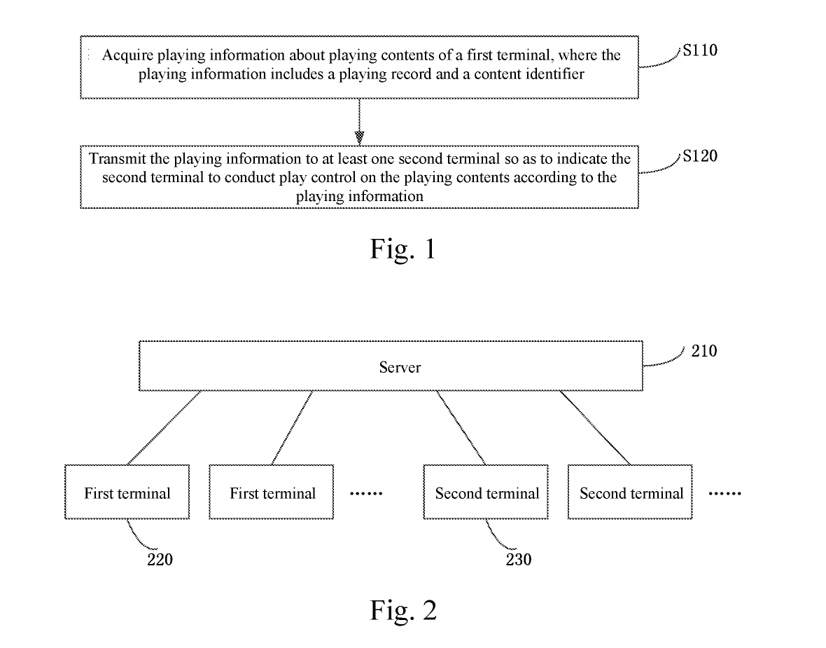

FIG. 1 is a flow diagram showing a method for multi-screen switching provided in embodiments of the present application. FIG. 2 is a schematic diagram showing a system architecture used in a method for multi-screen switching provided in embodiments of the present application. The system architecture includes a server 210, at least one first terminal 220 and at least one second terminal 230, where data interaction can be performed between the server 210 and the first terminal 220 and between the server 210 and the second terminal 230 through a wireless communication technology. Exemplarily, the method for multi-screen switching of embodiments can be executed by the server.

Referring to FIG. 1, the method for multi-screen switching includes operations as follows.

In S110, playing information about playing contents of a first terminal is acquired, where the playing information includes a playing record and a content identifier.

In the above operation, the server can actively transmit a command for acquiring the playing information to the first terminal so as to indicate the first terminal to transmit the playing information according to the command. Or, the first terminal can actively transmit the playing information to the server, and the server obtains the playing information.

For example, if the user watches certain playing content through the first terminal, the server actively transmits a command for acquiring the playing information to the first terminal when the server detects that the user exists within a visual range of a front camera of the second terminal; and after receiving the command, the first terminal records playing information about the playing content at this moment and transmits the playing information to the server. Or, if the user watches certain playing content through the first terminal and needs to close the playing content due to individual reasons or inadequate power of the first terminal and the like, the first terminal records the playing information about the playing content and transmits the playing information to the server when it is detected that the playing content is closed. Or, the first terminal can update the recorded playing information about the playing content every time T; after receiving the command for acquiring the playing information transmitted by the server, playing information at time T most adjacent to a moment of receiving the command is transmitted to the server; or when it is detected that the playing content of the first terminal is closed, playing information at time T most adjacent to a closing time is transmitted to the server.

Alternatively, the playing information includes a playing record and a content identifier of the playing contents, where the playing record includes at least one of an exiting time of the playing contents of the first terminal, a data frame of the exiting time, and picture information about the exiting time; and the content identifier includes at least one of a name and an address of the playing contents of the first terminal.

It should be noted here that the playing contents may further include an identifier of the first terminal; the identifier may be a serial number and/or name of the first terminal; the server determines a second terminal having a binding relationship with the first terminal according to the identifier of the first terminal; or the playing contents may further include an identifier of the second terminal; the identifier may be a serial number and/or name of the second terminal; and the server transmits the playing information to the second terminal according to the identifier of the second terminal.

In addition, the first terminal can record the playing information about the playing contents in many modes; for example, the first terminal updates the recorded playing information about the playing contents of the first terminal every preset time T, or

the playing information about the playing contents of the first terminal is recorded when a command transmitted by the server for acquiring the playing information about the playing contents of the first terminal is detected, or

the playing information about the playing contents is recorded when the first terminal controls an exiting operation of the playing contents.

In S120, the playing information is transmitted to at least one second terminal so as to indicate the second terminal to conduct play control on the playing contents according to the playing information.

In the above operation, the server transmits the acquired playing information to at least one second terminal so as to indicate the second terminal to conduct play control on the playing contents of the first terminal according to the playing information, where the server can transmit the playing information to all the second terminals, and can also selectively transmit the playing information to part of the second terminals; and the second terminal may have a binding relationship with the first terminal or may be designated by the first terminal.

In one alternative implementation mode of the present embodiment, the server acquires at least one second terminal bound with the first terminal according to a terminal binding relationship, and transmits the playing information to at least one second terminal so as to indicate the second terminal to conduct play control on the playing contents according to the playing information.

Alternatively, when the content identifier acquired in the playing information transmitted by the first terminal is a name of the playing contents, the server can directly transmit the name of the playing contents and the playing record to at least one second terminal to indicate the second terminal to determine an address of the playing contents according to the name of the playing contents so as to determine resources of the playing contents according to the playing address and play the playing contents according to the playing record.

Or, the server can also determine an address of resources of the playing contents according to the name of the playing contents, and transmit the address of the playing contents and the playing record to at least one second terminal so as to indicate the second terminal to directly determine resources of the playing contents according to the address of the playing contents and play the playing contents according to the playing record.

Benefits of configuring in this way are as follows. The server analyzes the acquired playing information, thereby reducing performance requirements for an arithmetic unit and a processor of the second terminal and reducing the cost of the second terminal.

In addition, the first terminal and the second terminal mentioned in embodiments of the present application represent names of the terminals under a specific application environment, and do not represent differences between different terminals. Within a specific time period, a certain terminal as the first terminal transmits the playing information about the playing contents to the server, but in other time periods, the terminal can also receive the playing information transmitted by the server as the second terminal. Of course, in technical solutions of embodiments of the present application, terminals having specific functions are not excluded, i.e., one kind of terminals can only act as the first terminal for transmitting the playing information to the server, rather than act as the second terminal; while another kind of terminals can only act as the second terminal for receiving the playing information transmitted by the server, rather than act as the first terminal.

In technical solutions provided in the present embodiment, the server acquires the playing information about the playing contents transmitted by the first terminal, and transmits the playing information to at least one second terminal so as to indicate the at least one second terminal to play the playing contents according to the playing information, so that the playing contents are switched freely among a plurality of terminals.

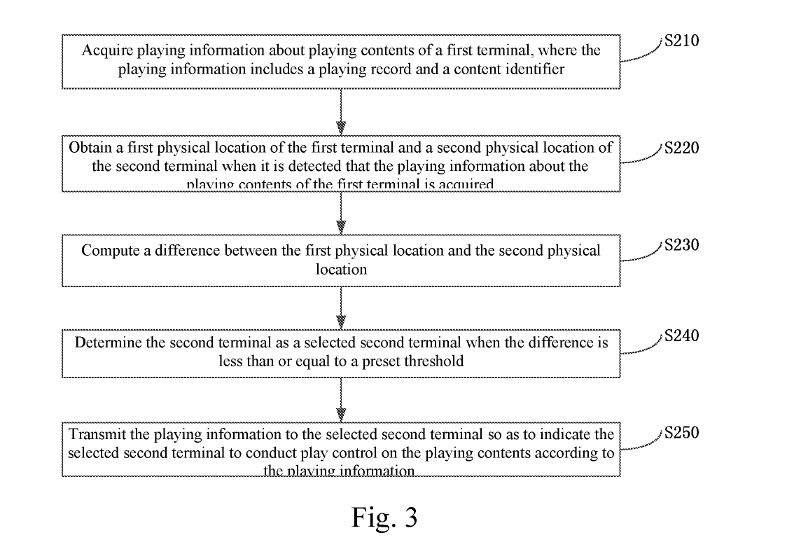

FIG. 3 is a flow diagram showing a method for multi-screen switching provided in embodiments of the present application. Based on the above embodiments, the method in the present embodiment is still described as an example by applying in the server. After acquired by the server, the playing information about the playing contents of the first terminal may be optimized in a manner of transmitting the playing information to the second terminal so that management on the second terminal is more pointed, where the playing information can be transmitted to the second terminal in many manners which can be adopted individually or jointly.

Referring to FIG. 3, the server manages the second terminal according to physical locations of the first terminal and the second terminal. The method for multi-screen switching includes operations as follows.

In S210, playing information about playing contents of a first terminal is acquired, where the playing information includes a playing record and a content identifier.

In S220, a first physical location of the first terminal and a second physical location of the second terminal are obtained when it is detected that the playing information about the playing contents of the first terminal is acquired.

The first physical location of the first terminal is acquired and the second physical location of at least one second terminal is respectively acquired when the server detects that the playing information about the playing contents of the first terminal is acquired. The first physical location and the second physical location are physical locations when the first terminal transmits the playing information to the server, where respective physical locations of the first terminal and the second terminal can be determined by GPS, and can be stored in a coordinate form.

Exemplarily, illustration is made by taking three second terminals as an example. When the server detects that the playing information is acquired, the acquired first physical location of the first terminal is A(x1,y1), and the second physical locations of three second terminals are respectively a second physical location B1(x2,y2), a second physical location B2(x3,y3) and a second physical location B3(x4,y4).

In S230, differences between the first physical location and the second physical locations are computed.

The first physical location of the first terminal and the second physical locations of three second terminals acquired in operation S220 are processed to respectively compute a difference M between each second physical location and the first physical location, where a difference between the first physical location A and the second physical location B1 is M1=\sqrt{(x2−x1)²+(y2−y1)²}, a difference between the first physical location A and the second physical location B2 is M2=\sqrt{(x3−x1)²+(y3−y1)²}, and a difference between the first physical location A and the second physical location B3 is M3=\sqrt{(x4−x1)²+(y4−y1)²}.

In S240, the second terminal is determined as a selected second terminal when the difference is less than or equal to a preset threshold.

The difference between the first physical location and each second physical location computed in operation S240 is compared with the preset threshold; and the second terminal corresponding to the second physical location is determined as the selected second terminal when the difference is less than or equal to the preset threshold;

where the preset threshold is preset manually or set by the server by default. By comparing the difference between the first physical location and each second physical location with the preset threshold, the server can be facilitated to manage the second terminals more targetedly.

In S250, the playing information is transmitted to the selected second terminal so as to indicate the selected second terminal to conduct play control on the playing contents according to the playing information.

In technical solutions of the present embodiment, after the playing information about the playing contents of the first terminal is acquired through the server, the first physical location of the first terminal and the second physical locations of all the second terminals are also acquired; differences between the first physical location and various second physical locations are obtained through computing, various differences are compared with the preset threshold, and the second terminal corresponding to the second physical location is determined as the selected second terminal when the difference is less than or equal to the preset threshold; and the server transmits the playing information to the selected second terminal so as to indicate the selected second terminal to conduct play control on the playing information, so that it is achieved that the server manages the second terminals more targetedly, a waste of resources due to transmission of a large number of playing information is reduced, and management efficiency is increased.

Based on the above technical solution, alternatively, after it is detected that the playing information transmitted by the first terminal is acquired, the server can also manage the second terminals according to current time based on a preset rule.

Exemplarily, the preset rule may be a rule which is preset and stored by the user in the server. The user first establishes correlations between the first terminal and the second terminals in the server. The correlations can be stored in a tabular form or a graphical form, and multiple correlations can be established. For example, a first correlation is established between the first terminal and second terminals (e.g., computers, mobile phones and other terminals configured in a company) used in operation, and a second correlation is established between the first terminal and second terminals (e.g., home computers, televisions, mobile phones and other terminals) used in life. When the server detects that the playing information transmitted by the first terminal is acquired, corresponding time of acquiring the playing information is recorded, analyzed and judged; when the time is judged as working time (e.g., 9:00-12:00 and 13:00-17:00 from Monday to Friday), the server transmits the playing information to the second terminals in the first correlation; and when the time is judged as other time (generally, 6:00-9:00 and 17:00-19:00 from Monday to Friday, or Saturday and Sunday), the server transmits the playing information to the second terminals in the second correlation.

In addition, the server can also perform self-learning according to a selection of the user on the second terminals to form the preset rule. Exemplarily, when times the user selected a certain second terminal within a same time period reach a preset value, the server has self-learned the operation and adds the operation to the preset rule. For example, description is made by taking the preset value of 5 days as an example. After the server transmits the playing information to at least one second terminal, if the user always selects a certain second terminal to continuously play the playing contents of the first terminal within a same time period of continuous 5 days, then the server performs self-learning on the operation to form a preset rule for the first terminal and the second terminal within the time period.

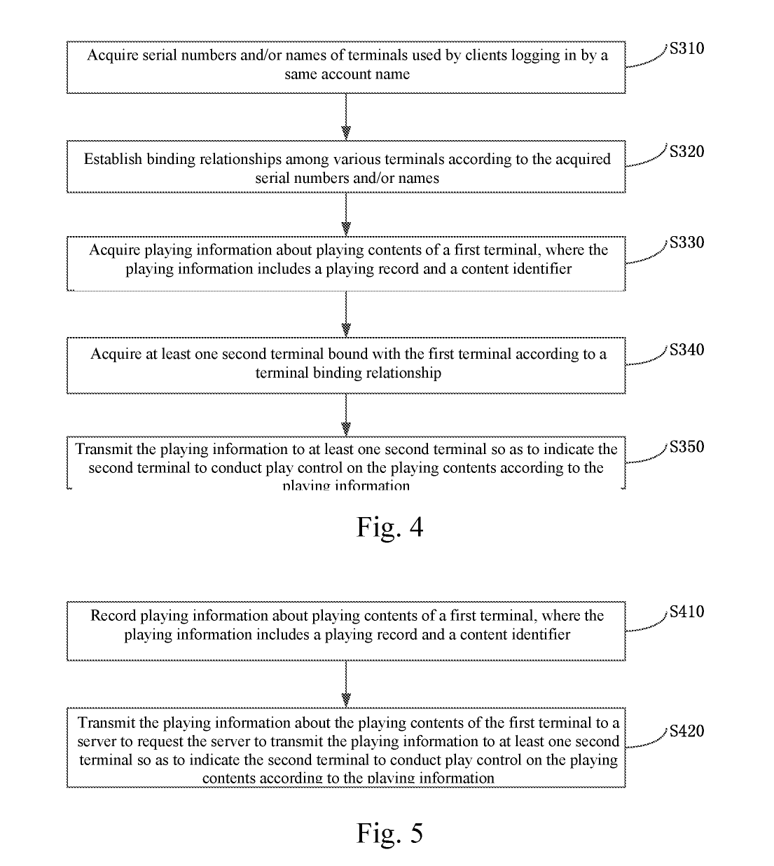

FIG. 4 is a flow diagram showing a method for multi-screen switching provided in embodiments of the present application. Based on the above embodiment, a binding operation among terminals is added in the present embodiment. Exemplarily, the method for multi-screen switching is still executed by the server.

Referring to FIG. 4, the terminal corresponds to a client logging in by a same account name. The method for multi-screen switching includes operations as follows.

In S310, serial numbers and/or names of terminals used by clients logging in by a same account name are acquired.

In the above operation, serial numbers and/or names of the terminals are identifiers for identifying the terminals by the server, and serial numbers and the names as two kinds of different identifiers can be used for uniquely identifying the terminals.

The server acquires a binding request transmitted by the terminal. The binding request includes serial numbers and/or names of the terminals as well as a login account name of the clients in the terminals.

In S320, a binding relationship among the terminals is established according to the acquired serial numbers and/or names.

The server first extracts serial numbers and/or names of the terminals used by the clients logging in by a same account name, and then establishes correlations among serial numbers and/or names, so as to achieve that binding relationships among the terminals corresponding to serial numbers and/or names are established.

In S330, playing information about playing contents of a first terminal is acquired, where the playing information includes a playing record and a content identifier.

In S340, at least one second terminal bound with the first terminal is acquired according to a terminal binding relationship.

In S350, the playing information is transmitted to at least one second terminal so as to indicate the second terminal to conduct play control on the playing contents according to the playing information.

In technical solutions of the present embodiment, the server first establishes binding relationships among the terminals used by the clients logging in by a same account name before acquiring the playing information, so as to determine at least one second terminal according to the binding relationships and transmit the playing information to at least one second terminal having the binding relationship with the first terminal, so that the server manages the second terminal more targetedly, a waste of resources due to transmission of a large number of playing information is reduced, and management efficiency for the second terminal is increased.

In the above embodiment, the server can automatically determine serial numbers and/or names of the terminals which need to establish binding relationships among various terminals according to the account names of the clients, without manually selecting serial numbers and/or names of the terminals which need to establish binding relationships by the user.

Based on the above embodiment, alternatively, the server first acquires serial numbers and/or names of the terminals before acquiring the playing information; the user manually selects terminals which need to establish binding relationships according to serial numbers and/or names of various terminals; and the server establishes binding relationships among the terminals according to user selections. Benefits of configuring in this way are as follows. The user can achieve binding relationship establishment among various terminals without account registering in the clients of the terminals, thereby saving user time, and use experience of a user is enhanced.

FIG. 5 is a flow diagram showing another method for multi-screen switching provided in embodiments of the present application. The method is still applicable to a system architecture shown in FIG. 2. Exemplarily, the method for multi-screen switching of the present embodiment is executed by the first terminal, and can be executed by matching with the above method for multi-screen switching realized by the server.

Referring to FIG. 5, the method for multi-screen switching includes operations as follows.

In S410, playing information about playing contents of a first terminal is recorded, where the playing information includes a playing record and a content identifier.

In the above operation, the playing record includes at least one of an exiting time of the playing contents of the first terminal, a data frame of the exiting time, and picture information about the exiting time; and the content identifier includes at least one of a name and an address of the playing contents of the first terminal.

The first terminal can update the recorded playing information about the playing contents of the first terminal by certain preset time T; or can record the playing information about the playing contents of the first terminal when a command transmitted by a server for acquiring the playing information about the playing contents of the first terminal is detected; or can record the playing information about the playing contents when the first terminal controls an exiting operation of the playing contents.

In S420, the playing information about the playing contents of the first terminal is transmitted to a server to request the server to transmit the playing information to at least one second terminal so as to indicate the second terminal to conduct play control on the playing contents according to the playing information.

The first terminal transmits the playing information about the playing contents of the first terminal to the server so as to request the server to transmit the playing information to at least one second terminal having binding relationships with the first terminal; the binding relationships are established by the server, and a realizing process can be achieved with reference to the operation of the above embodiment;

or, the first terminal transmits the playing information about the playing contents of the first terminal to the server so as to request the server to transmit the playing information to at least one second terminal specified by the first terminal. For example, the first terminal transmits identifiers of the second terminals to the server while transmitting the playing information to the server, and the identifiers of the second terminal may be serial numbers and/or names of the second terminals. After acquiring the playing information and the identifiers of the second terminals, the server transmits the playing information to the second terminals so as to indicate the second terminals to conduct play control on the playing contents according to the playing information.

In technical solutions of the present embodiment, the playing information about the playing contents is recorded through the first terminal and the recorded playing information is transmitted to the server to request the server to transmit the playing information to at least one second terminal so as to indicate the second terminal to conduct play control on the playing contents according to the playing information. Thus, switching of the playing contents among the first terminal and the second terminal is achieved.

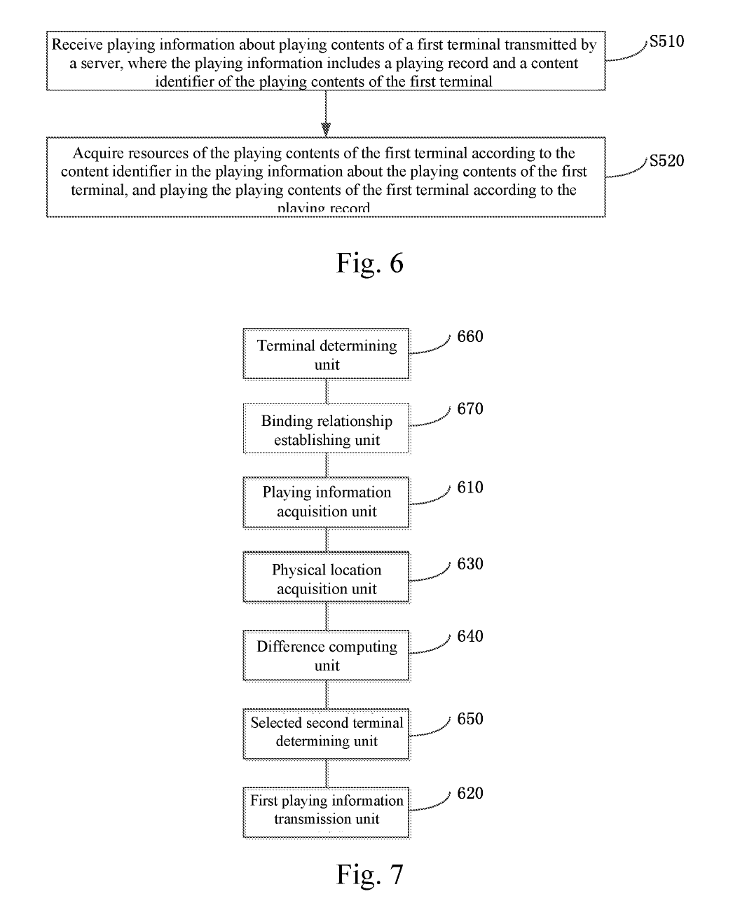

FIG. 6 is a flow diagram showing another method for multi-screen switching provided in embodiments of the present application. The method is still applicable to a system architecture shown in FIG. 2. Exemplarily, the method for multi-screen switching of the present embodiment is executed by the second terminal, and can be executed by matching with the above method for multi-screen switching realized by the server.

Referring to FIG. 6, the method for multi-screen switching includes operations as follows.

In S510, the playing information about the playing contents of the first terminal transmitted by the server is received, where the playing information includes a playing record and a content identifier of the playing contents of the first terminal.

When receiving the playing information about the playing contents of the first terminal transmitted by the server, the second terminal can be in an operating state or in a shutdown state. When the second terminal is in the operating state, the second terminal can prompt the user using the second terminal whether to switch playing contents on the second terminal to the playing contents on the first terminal after receiving the playing information; and when the second terminal is in the shutdown state, the second terminal can save the playing information after receiving the playing information, and the second terminal prompts the user starting the second terminal whether to continue to watch the playing contents of the first terminal when the second terminal is started.

It should be noted here that, when the user watches the playing contents by using the client in the first terminal, the client in the second terminal can be in an exit state or a background running state. When the client is in the exit state, the second terminal prompts the user whether to continue to watch the playing contents of the first terminal when the user starts the client after the second terminal receives the playing information; however, when the client is in the background running state, the second terminal can directly prompt the user whether to continue to watch the playing contents of the first terminal after receiving the playing information.

Of course, the second terminal can directly play the playing contents of the first terminal according to the playing information without prompting the user whether to continue to watch the playing contents of the first terminal.

In addition, when the second terminal is in the shutdown state, the second terminal saves the received playing information about the playing contents of the first terminal; and the second terminal can simultaneously save playing information about playing contents of other first terminals if the second terminal also receives the playing information about the playing contents of other first terminals before the second terminal is started to operate, so as to prompt various items of saved playing information item by item after startup;

or, after receiving the playing information about the playing contents of the first terminal transmitted by the server, the second terminal compares the playing information about the playing contents of other first terminals with the playing information about the playing contents of the first terminal if the second terminal also receives the playing information about the playing contents of other first terminals; when a content identifier in the playing information about the playing contents of other first terminals is as same as a content identifier in the playing information about the playing contents of the first terminal and a playing record in the playing information about the playing contents of other first terminals is different from a playing record in the playing information about the playing contents of the first terminal, the playing information about the playing contents of the first terminal is replaced with the playing information about the playing contents of other first terminals; and when the content identifier in the playing information about the playing contents of other first terminals is different from the content identifier in the playing information about the playing contents of the first terminal, the playing information about the playing contents of other first terminals is also saved.

In S520, resources of the playing contents of the first terminal are acquired according to the content identifier in the playing information about the playing contents of the first terminal, and the playing contents of the first terminal are played according to the playing record.

The second terminal can directly continue to play the playing contents of the first terminal according to the playing information, or can start a play continuation function only when the user selects to continue to play the playing contents of the first terminal.

In one alternative embodiment of the present embodiment, the second terminal first detects whether a user exists within a visual range of a front camera of the second terminal or detects whether the second terminal is in an operating state;

if yes, the second terminal prompts the user whether to play the playing contents of the first terminal; or, if yes, the second terminal acquires resources of the playing contents of the first terminal according to the content identifier in the playing information about the playing contents of the first terminal, and plays the playing contents of the first terminal according to the playing record.

If it is detected that no user exists within the visual range of the front camera of the second terminal, the second terminal transmits a none valid user command to the server so as to indicate the server to transmit the playing information about the playing contents of the first terminal to other second terminals; or

if it is detected that the second terminal is in the shutdown state and is still in the shutdown state within a specified preset time, the second terminal transmits a none valid user command to the server so as to indicate the server to transmit the playing information about the playing contents of the first terminal to other second terminals.

In technical solutions of the present embodiment, the second terminal receives the playing information about the playing contents of the first terminal transmitted by the server, and indicates the second terminal to continue to play the playing contents of the first terminal according to the playing information, so that switching of the playing contents among the first terminal and the second terminals is achieved.

FIG. 7 is a schematic structural diagram showing a server for multi-screen switching provided in embodiment of the present application. Referring to FIG. 7, the structure of the server includes: a playing information acquisition unit 610 and a first playing information transmission unit 620, where

the playing information acquisition unit 610 is configured to acquire the playing information about the playing contents of the first terminal, where the playing information includes a playing record and a content identifier;

the first playing information transmission unit 620 is configured to transmit the playing information to at least one second terminal so as to indicate the second terminal to conduct play control on the playing contents according to the playing information,

where the playing record includes at least one of an exiting time of the playing contents of the first terminal, a data frame of the exiting time, and picture information about the exiting time; and the content identifier includes at least one of a name and an address of the playing contents of the first terminal.

Alternatively, the first playing information transmission unit 620 is configured for:

acquiring at least one second terminal bound with the first terminal according to a terminal binding relationship;

transmitting the playing information to at least one second terminal so as to indicate the second terminal to conduct play control on the playing contents according to the playing information.

In addition, alternatively, the first playing information transmission unit 620 is configured for:

transmitting the playing information to at least one second terminal so as to indicate the second terminal to determine resources of the playing contents according to the content identifier and play the playing contents according to the playing record.

Based on the above technical solution, alternatively, the server further includes

a physical location acquisition unit 630, which is configured to obtain a first physical location of the first terminal and a second physical location of the second terminal when it is detected that the playing information about the playing contents of the first terminal is acquired after acquiring the playing information about the playing contents of the first terminal;

a difference computing unit 640, which is configured to compute a difference between the first physical location and the second physical location; and

a selected second terminal determining unit 650, which is configured to determine the second terminal as a selected second terminal when the difference is less than or equal to a preset threshold;

accordingly, the first playing information transmission unit 620 is configured for:

transmitting the playing information to the selected second terminal so as to indicate the selected second terminal to conduct play control on the playing contents according to the playing information.

Alternatively, the server may further include:

a terminal determining unit 660, which is configured to acquire serial numbers and/or names of terminals used by clients logging in by a same account name before acquiring the playing information about the playing contents of the first terminal; and

a binding relationship establishing unit 670, which is configured to establish binding relationships among various terminals according to the acquired serial numbers and/or names.

The product described in the present embodiment can execute the method for multi-screen switching executed by the server provided in any embodiment of the present application, and has corresponding function modules for executing the method.

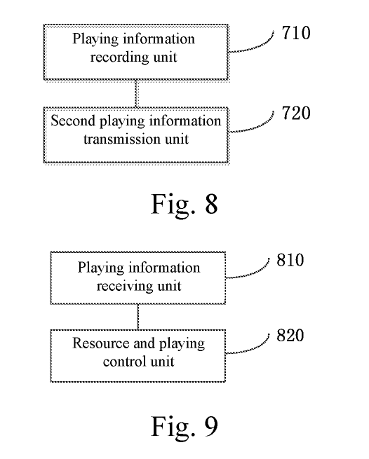

FIG. 8 is a schematic structural diagram showing another terminal for multi-screen switching provided in embodiments of the present application. Exemplarily, the terminal for multi-screen switching is a first terminal. Referring to FIG. 8, a structure of the first terminal includes: a playing information recording unit 710 and a second playing information transmission unit 720, where

the playing information recording unit 710 is configured to record the playing information about the playing contents of the first terminal, where the playing information includes a playing record and a content identifier; and

the second playing information transmission unit 720 is configured to transmit the playing information about the playing contents of the first terminal to a server to request the server to transmit the playing information to at least one second terminal so as to indicate the second terminal to conduct play control on the playing contents according to the playing information.

Alternatively, the playing information recording unit 710 is configured for:

updating the recorded playing information about the playing contents of the first terminal every preset time T; or

recording the playing information about the playing contents of the first terminal when a command transmitted by the server for acquiring the playing information about the playing contents of the first terminal is detected; or

recording the playing information about the playing contents when the first terminal controls an exiting operation of the playing contents.

The product described in the present embodiment can execute the multi-screen switching method executed by a mobile terminal provided in any embodiment of the present application, and has corresponding function modules for executing the method.

FIG. 9 is a schematic structural diagram showing a terminal for multi-screen switching provided in embodiments of the present application. Exemplarily, the terminal for multi-screen switching is a second terminal. Referring to FIG. 9, a structure of the second terminal includes: a playing information receiving unit 810 and a resource and playing control unit 820, where

the playing information receiving unit 810 is configured to receive the playing information about the playing contents of the first terminal transmitted by the server, where the playing information includes a playing record and a content identifier of the playing contents of the first terminal; and

the resource and playing control unit 820 is configured to acquire resources of the playing contents of the first terminal according to the content identifier in the playing information about the playing contents of the first terminal, and playing the playing contents of the first terminal according to the playing record.

Alternatively, the resource and playing control unit 820 is configured for:

detecting whether a user exists within a visual range of a front camera of the second terminal, or detecting whether the second terminal is in an operating state;

if yes, prompting the user whether to play the playing contents of the first terminal; or, if yes, acquiring resources of the playing contents of the first terminal according to the content identifier in the playing information about the playing contents of the first terminal, and playing the playing contents of the first terminal according to the playing record.

The product described in the present embodiment can execute the method for multi-screen switching executed by the server provided in any embodiment of the present application, and has corresponding function modules for executing the method.

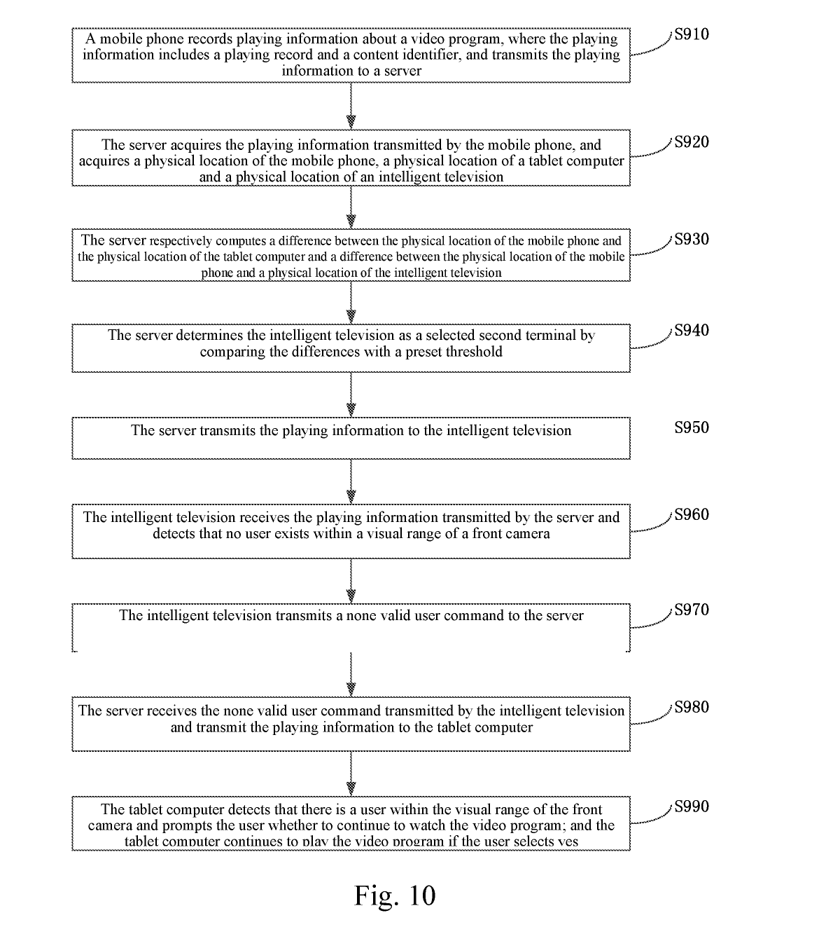

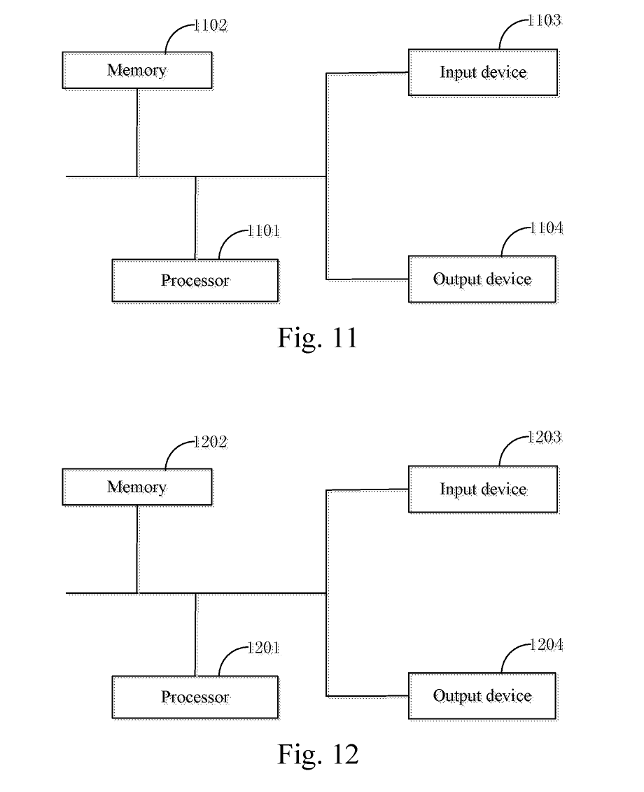

FIG. 10 is a flow diagram showing another method for multi-screen switching provided in embodiments of the present application. In the present embodiment, based on the above embodiment, an alternative embodiment is provided in such an application scenario that the user has a mobile phone, a tablet computer and an intelligent television at a same time and watches the video program with the mobile phone.

At this moment, the mobile phone of the user is a first terminal, the tablet computer is a second terminal, the intelligent television is another second terminal, and binding relationships are established among the terminals.

Referring to FIG. 10, the method for multi-screen switching includes operations as follows.

In S910, playing information about the video program is recorded by the mobile phone, where the playing information includes a playing record and a content identifier, and the playing information is transmitted to the server;

In S920, the server acquires the playing information transmitted by the mobile phone, and acquires a physical location of the mobile phone, a physical location of the tablet computer and a physical location of the intelligent television;

In S930, the server respectively computes a difference between the physical location of the mobile phone and the physical location of the tablet computer and a difference between the physical location of the mobile phone and the physical location of the intelligent television;

In S940, the server determines the intelligent television as a selected second terminal by comparing the differences with a preset threshold;

In S950, the server transmits the playing information to the intelligent television;

In S960, the intelligent television receives the playing information transmitted by the server and detects that no user exists within a visual range of a front camera;

In S970, the intelligent television transmits a none valid user command to the server;

In S980, the server receives the none valid user command transmitted by the intelligent television and transmits the playing information to the tablet computer; and

In S990, the tablet computer detects that there is a user within the visual range of the front camera and prompts the user whether to continue to watch the video program; and the tablet computer continues to play the video program if the user selects yes.

In the present embodiment, the none valid user command is transmitted to the server if the tablet computer detects that there is no user within the visual range of the front camera; and a none available playing terminal command is transmitted to the first terminal if the server detects that there is no available second terminal at this moment, so as to prompt the user that no other terminal is available for continuing to play the video program.

In technical solutions provided in the present embodiment, the mobile phone as the first terminal transmits the playing information about the video program to the server; the server transmits the playing information to the selected second terminal, i.e., the intelligent television; the intelligent television first detects the existence of a user, and transmits the none valid user command to the server when there is no user; the server transmits the playing information to another second terminal, i.e., the tablet computer, according to the received none valid user command transmitted by the intelligent television; thus, the tablet computer detects the existence of a user, and prompts a user whether to continue to watch the video program when there is a user. Not only pointed management over the second terminal is realized, but also switching of the video program between the first terminal and the second terminal is realized.

Embodiments of the present application provide a non-transitory computer storage medium, where a computer executable instruction is stored in the computer storage medium, and the computer executable instruction is used for executing any method for multi-screen switching on a server side in embodiments of the present application.

Embodiments of the present application provide a non-transitory computer storage medium, where a computer executable instruction is stored in the computer storage medium, and the computer executable instruction is used for executing any method for multi-screen switching on a first terminal side in embodiments of the present application.

Embodiments of the present application provide a non-transitory computer storage medium, where a computer executable instruction is stored in the computer storage medium, and the computer executable instruction is used for executing any method for multi-screen switching on a second terminal side in embodiments of the present application.

FIG. 11 is a functional block diagram showing a hardware structure of a server provided in embodiments of the present application. As shown in FIG. 11, the server includes:

at least one processor 1101 and a memory 1102. One processor 1101 is taken as an example in FIG. 11.

The server may further include: an input device 1103 and an output device 1104.

The processor 1101, the memory 1102, the input device 1103 and the output device 1104 in the server can be connected by a bus or in other manners, and a connection by the bus is taken as an example in FIG. 11.

As a non-transitory computer readable storage medium, the memory 1102 may be used for storing non-transitory software programs, non-transitory computer executable programs and modules, such as program instructions/modules (e.g., the playing information acquisition unit 610, the first playing information transmission unit 620, the physical location acquisition unit 630, the difference computing unit 640, a selected second terminal determining unit 650, the terminal determining unit 660 and the binding relationship establishing unit 670 shown in FIG. 7) corresponding to the method for multi-screen switching in embodiments of the present application. The processor 1101 executes various function applications and data processing of the server by operating the non-transitory software programs, instructions and modules stored in the memory 1102, that is, the method for multi-screen switching on a server side in the above-mentioned method embodiments is realized.

The memory 1102 may include a program storage area and a data storage area, where the program storage area may store an operating system and application programs required for at least one function; and the data storage area may store data and the like created according to use of the server. In addition, the memory 1102 may include a high-speed random access memory, and may further include a non-transitory memory such as at least one magnetic disk memory device, a flash memory device or other non-transitory solid-state memory device. In some embodiments, the memory 1102 may selectively include memories remotely arranged relative to the processor 1101, where these remote memories may be connected to the server by a network. An example of the above-mentioned network includes but is not limited to an Internet, an Intranet, a local area network, a mobile communication network and a combination thereof.

The input device 1103 may be used for receiving input digit or character information, and producing key signal input related to user setting and function control of the server. The output device 1104 may include a display device such as a display screen.

The at least one module is stored in the memory 1102, and executes the method for multi-screen switching in any of the above-mentioned method embodiments when being executed by the at least one processor 1101.

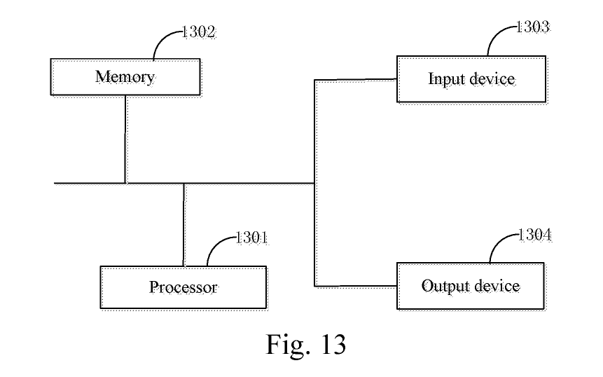

FIG. 12 is a functional block diagram showing a hardware structure of a first terminal provided in embodiments of the present application. As shown in FIG. 12, the first terminal includes:

at least one processor 1201 and a memory 1202. One processor 1201 is taken as an example in FIG. 12.

The first terminal may further include: an input device 1203 and an output device 1204.

The processor 1201, the memory 1202, the input device 1203 and the output device 1204 in the first terminal can be connected by a bus or in other manners, and a connection by the bus is taken as an example in FIG. 12.

As a non-transitory computer readable storage medium, the memory 1202 may be used for storing non-transitory software programs, non-transitory computer executable programs and modules, such as program instructions/modules (e.g., the playing information recording unit 710 and the second playing information transmission unit 720 shown in FIG. 8) corresponding to the method for multi-screen switching in embodiments of the present application. The processor 1201 executes various function applications and data processing of the server by operating the non-transitory software programs, instructions and modules stored in the memory 1202, that is, the method for multi-screen switching on a first terminal side in the above-mentioned method embodiments is realized.

The memory 1202 may include a program storage area and a data storage area, where the program storage area may store an operating system and application programs required for at least one function; and the data storage area may store data and the like created according to use of the first terminal. In addition, the memory 1202 may include a high-speed random access memory, and may further include a non-transitory memory such as at least one magnetic disk memory device, a flash memory device or other non-transitory solid-state memory device. In some embodiments, the memory 1202 may selectively include memories remotely arranged relative to the processor 1201, where these remote memories may be connected to the first terminal by a network. An example of the above-mentioned network includes but is not limited to an Internet, an Intranet, a local area network, a mobile communication network and a combination thereof.

The input device 1203 may be used for receiving input digit or character information, and producing key signal input related to user setting and function control of the first terminal. The output device 1204 may include a display device such as a display screen.

The at least one module is stored in the memory 1202, and executes the method for multi-screen switching in any of the above-mentioned method embodiments when being executed by the at least one processor 1201.

FIG. 13 is a functional block diagram showing a hardware structure of a second terminal provided in embodiments of the present application. As shown in FIG. 13, the second terminal includes:

at least one processor 1301 and a memory 1302. One processor 1301 is taken as an example in FIG. 13.

The second terminal may further include: an input device 1303 and an output device 1304.

The processor 1301, the memory 1302, the input device 1303 and the output device 1304 in the second terminal can be connected by a bus or in other manners, and a connection by the bus is taken as an example in FIG. 13.

As a non-transitory computer readable storage medium, the memory 1302 may be used for storing non-transitory software programs, non-transitory computer executable programs and modules, such as program instructions/modules (e.g., the playing information receiving unit 810 and the resource and playing control unit 820 shown in FIG. 9) corresponding to the method for multi-screen switching in embodiments of the present application. The processor 1301 executes various function applications and data processing of the server by operating the non-transitory software programs, instructions and modules stored in the memory 1302, that is, the method for multi-screen switching on a second terminal side in the above-mentioned method embodiments is realized.

The memory 1302 may include a program storage area and a data storage area, where the program storage area may store an operating system and application programs required for at least one function; and the data storage area may store data and the like created according to use of the second terminal. In addition, the memory 1302 may include a high-speed random access memory, and may further include a non-transitory memory such as at least one magnetic disk memory device, a flash memory device or other non-transitory solid-state memory device. In some embodiments, the memory 1302 may selectively include memories remotely arranged relative to the processor 1301, where these remote memories may be connected to the second terminal by a network. An example of the above-mentioned network includes but is not limited to an Internet, an Intranet, a local area network, a mobile communication network and a combination thereof.

The input device 1303 may be used for receiving input digit or character information, and producing key signal input related to user setting and function control of the second terminal. The output device 1304 may include a display device such as a display screen.

The at least one module is stored in the memory 1302, and executes the method for multi-screen switching in any of the above-mentioned method embodiments when being executed by the at least one processor 1301.

The above-mentioned product can execute the method provided in embodiments of the present application, and has a corresponding function module for executing the method and beneficial effects. See the method provided in embodiments of the present application for technical details not described in this embodiment in detail.

The electronic equipment in embodiments of this application exists in various forms, including but not limited to:

(1) mobile telecommunication device. A device of this kind has a feature of mobile communicating function, and has a main object of providing voice and data communication. Devices of this kind include smart phone (such as iPhone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

What is claimed is:

1. A method for multi-screen switching, executed by an electronic device, comprising:
acquiring playing information about playing contents of a first terminal, wherein the playing information includes a playing record and a content identifier; and
transmitting the playing information to at least one second terminal so as to indicate the second terminal to conduct play control on the playing contents according to the playing information.

2. The method according to claim 1, wherein the playing record comprises at least one of an exiting time of the playing contents of the first terminal, a data frame of the exiting time, and picture information about the exiting time, and wherein the content identifier comprises at least one of a name and an address of the playing contents of the first terminal.

3. The method according to claim 1, wherein the transmitting the playing information to at least one second terminal so as to indicate the second terminal to conduct play control on the playing contents according to the playing information comprises:
acquiring at least one second terminal bound with the first terminal according to a terminal binding relationship; and
transmitting the playing information to the at least one second terminal so as to indicate the second terminal to conduct play control on the playing contents according to the playing information.

4. The method according to claim 1, wherein the transmitting the playing information to at least one second terminal so as to indicate the second terminal to conduct play control on the playing contents according to the playing information comprises:
transmitting the playing information to at least one second terminal so as to indicate the second terminal to determine resources of the playing contents according to the content identifier and play the playing contents according to the playing record.

5. The method according to claim 1, after acquiring the playing information about the playing contents of the first terminal, further comprising:
obtaining a first physical location of the first terminal and a second physical location of the second terminal when detecting that the playing information about the playing contents of the first terminal is obtained;
computing a difference between the first physical location and the second physical location; and
determining the second terminal as a selected second terminal when the difference is less than or equal to a preset threshold,
wherein, transmitting the playing information to at least one second terminal so as to indicate the second terminal to conduct play control on the playing contents according to the playing information comprises:
transmitting the playing information to the selected second terminal so as to indicate the selected second terminal to conduct play control on the playing contents according to the playing information.

6. The method according to claim 1, before acquiring the playing information about the playing contents of the first terminal, further comprising:
acquiring serial numbers and/or names of terminals used by clients logging in by a same account name; and
establishing binding relationships among various terminals according to the acquired serial numbers and/or names.

7. An electronic device, comprising:
at least one processor; and
a memory communicably connected with the at least one processor for storing instructions executable by the at least one processor, wherein execution of the instructions by the at least one processor causes the at least one processor to:
acquire playing information about playing contents of a first terminal, wherein the playing information comprises a playing record and a content identifier, and
transmit the playing information to at least one second terminal so as to indicate the second terminal to conduct play control on the playing contents according to the playing information.

8. The electronic device according to claim 7, wherein the playing record comprises at least one of an exiting time of the playing contents of the first terminal, a data frame of the exiting time, and picture information about the exiting time, and wherein the content identifier comprises at least one of a name and an address of the playing contents of the first terminal.

9. The electronic device according to claim 7, wherein the transmitting the playing information to at least one second terminal so as to indicate the second terminal to conduct play control on the playing contents according to the playing information comprises:
acquiring at least one second terminal bound with the first terminal according to a terminal binding relationship; and
transmitting the playing information to at least one second terminal so as to indicate the second terminal to conduct play control on the playing contents according to the playing information.

10. The electronic device according to claim 7, wherein the transmitting the playing information to at least one second terminal so as to indicate the second terminal to conduct play control on the playing contents according to the playing information comprises:
transmitting the playing information to at least one second terminal so as to indicate the second terminal to determine resources of the playing contents according to the content identifier and play the playing contents according to the playing record.

11. The electronic device according to claim 7, wherein, the execution of the instructions by the at least one processor further causes the at least one processor to:
obtain a first physical location of the first terminal and a second physical location of the second terminal when detecting that the playing information about the playing contents of the first terminal is acquired after acquiring the playing information about the playing contents of the first terminal; and
compute a difference between the first physical location and the second physical location; and
determine the second terminal as a selected second terminal when the difference is less than or equal to a preset threshold,
wherein transmit the playing information to the at least one second terminal so as to indicate the second terminal to conduct play control on the playing contents according to the playing information comprises: transmit the playing information to the selected second terminal so as to indicate the selected second terminal to conduct play control on the playing contents according to the playing information.

12. The electronic device according to claim 7, wherein, the execution of the instructions by the at least one processor further causes the at least one processor to:
acquire serial numbers and/or names of terminals used by clients logging in by a same account name before acquiring the playing information about the playing contents of the first terminal; and
establish binding relationships among various terminals according to the acquired serial numbers and/or names.

13. A non-transitory computer-readable storage medium storing executable instructions that, when executed by an electronic device, cause the electronic device to:
acquire playing information about playing contents of a first terminal, wherein the playing information includes a playing record and a content identifier; and
transmit the playing information to at least one second terminal so as to indicate the second terminal to conduct play control on the playing contents according to the playing information.

14. The non-transitory computer-readable storage medium according to claim 13, wherein, the playing record comprises at least one of an exiting time of the playing contents of the first terminal, a data frame of the exiting time, and picture information about the exiting time and wherein the content identifier comprises at least one of a name and an address of the playing contents of the first terminal.

15. The non-transitory computer-readable storage medium according to claim 13, wherein, when transmitting the playing information to at least one second terminal so as to indicate the second terminal to conduct play control on the playing contents according to the playing information, the executable instructions cause the electronic device to:
acquire at least one second terminal bound with the first terminal according to a terminal binding relationship; and
transmit the playing information to at least one second terminal so as to indicate the second terminal to conduct play control on the playing contents according to the playing information.

16. The non-transitory computer-readable storage medium according to claim 13, wherein, when transmitting the playing information to at least one second terminal so as to indicate the second terminal to conduct play control on the playing contents according to the playing information, the executable instructions cause the electronic device to:
transmit the playing information to at least one second terminal so as to indicate the second terminal to determine resources of the playing contents according to the content identifier and play the playing contents according to the playing record.

17. The non-transitory computer-readable storage medium according to claim 13, wherein, the executable instructions further cause the electronic device to:
obtain a first physical location of the first terminal and a second physical location of the second terminal when detecting that the playing information about the playing contents of the first terminal is acquired after acquiring the playing information about the playing contents of the first terminal;
compute a difference between the first physical location and the second physical location; and
determine the second terminal as a selected second terminal when the difference is less than or equal to a preset threshold,
wherein transmit the playing information to the at least one second terminal so as to indicate the second terminal to conduct play control on the playing contents according to the playing information comprises: transmit the playing information to the selected second terminal so as to indicate the selected second terminal to conduct play control on the playing contents according to the playing information.

18. The non-transitory computer-readable storage medium according to claim 13, wherein, the executable instructions further cause the electronic device to:
acquire serial numbers and/or names of terminals used by clients logging in by a same account name before acquiring the playing information about the playing contents of the first terminal; and
establish binding relationships among various terminals according to the acquired serial numbers and/or names.
